(19) United States
(12) Patent Application Publication
(10) Pub. No.: US 2022/0192233 A1
(43) Pub. Date: Jun. 23, 2022

(54) ALCOHOL-FREE BEER-FLAVORED BEVERAGE

(71) Applicant: Suntory Holdings Limited, Osaka-shi, Osaka (JP)

(72) Inventors: Yohei Fujita, Takatsuki-shi, Osaka (JP); Yuichi Kato, Kokubunji-shi, Tokyo (JP)

(73) Assignee: Suntory Holdings Limited, Osaka-shi, Osaka (JP)

(21) Appl. No.: 17/605,352

(22) PCT Filed: Apr. 21, 2020
(86) PCT No.: PCT/JP2020/017198

§ 371 Date: Oct. 21, 2021

(30) Foreign Application Priority Data
Apr. 26, 2019 (JP) 2019-086162

(51) Int. Cl. A23L 2/00; A23L 29/00

(52) U.S. Cl. CPC A23L 2/00; A23L 29/035

(57) ABSTRACT

A nonalcoholic beer-taste beverage wherein the content of succinic acid is from 5 to 24 ppm. According to the present invention, a beer-taste beverage with a new taste having an excellent stimulating taste can be provided.

### TECHNICAL FIELD

The present invention relates to a nonalcoholic beer-taste beverage and a method for producing the same, and a method of giving a stimulating taste to a nonalcoholic beer-taste beverage.

### BACKGROUND ART

With the diversification of the inclinations of the consumers in the recent years, the development of nonalcoholic beer-taste beverages having various flavor characteristics has been desired. For example, Patent Publication 1 discloses that the acidic taste in a beer-taste malt beverage can be reduced or moderated with a pH adjusting agent by a combination of specific amino acid concentrations. On the other hand, in some cases a stimulating taste is desired in nonalcoholic beer-taste beverages, and addition of a carbon dioxide gas has been known as a method of giving a stimulating taste. However, no other methods of giving a stimulating taste have been known besides them.

### RELATED ART REFERENCES

### Patent Publications

Patent Publication 1: Japanese Patent Gazette No. 5231438

### SUMMARY OF THE INVENTION

### Problems to be Solved by the Invention

However, if a carbon dioxide gas pressure is increased in order to improve a stimulating taste, there are some disadvantages such that the stomach is undesirably bulged with carbon dioxide. Therefore, further improvements in giving a stimulating taste to nonalcoholic beer-taste beverages have been desired.

The present invention relates to the provision of a nonalcoholic beer-taste beverage having an excellent stimulating taste and a method for producing the same, and a method of giving a stimulating taste to a nonalcoholic beer-taste beverage.

### Means to Solve the Problems

The present invention relates to the followings [1] to [3]:

[1] A nonalcoholic beer-taste beverage wherein the content of succinic acid is from 5 to 24 ppm.
[2] A method for producing a nonalcoholic beer-taste beverage as defined in [1], including adding succinic acid and/or a salt thereof.
[3] A method of giving a stimulating taste to a nonalcoholic beer-taste beverage including adding succinic acid and/or a salt thereof.

### Effects of the Invention

According to the present invention, a nonalcoholic beer-taste beverage having an excellent stimulating taste and a method for producing the same, and a method for giving a stimulating taste to a nonalcoholic beer-taste beverage can be provided. Here, the stimulating taste in the present invention refers to a carbon dioxide stimulation, and according to the present invention, ones having an excellent stimulating taste can be provided without increasing a carbon dioxide gas pressure.

### MODES FOR CARRYING OUT THE INVENTION

In the nonalcoholic beer-taste beverage, the content of succinic acid is usually from 0 to 2 ppm or so. In addition, succinic acid has been known as umami (tastiness) ingredient, and a threshold value as the umami ingredient is set at 550 ppm. As a result of intensively studying the above problems, the inventors of the present invention have newly surprisingly found that a nonalcoholic beer-taste beverage having an excellent stimulating taste is obtained when succinic acid is added in a trace amount as a given concentration at a level that would not be used as an acidulant or purposed for giving umami.

The nonalcoholic beer-taste beverage of the present invention contains succinic acid. The content of succinic acid of the nonalcoholic beer-taste beverage of the present invention is 5 ppm or more, preferably 8 ppm or more, and more preferably 11 ppm or more, from the viewpoint of strengthening the stimulating taste, and the content is 24 ppm or less, preferably 22 ppm or less, and more preferably 20 ppm or less, from the same viewpoint, and the content may be within the range of any of the combinations given above. The content of succinic acid as used herein is measured by HPLC method.

The carbon dioxide gas concentration of the nonalcoholic beer-taste beverage of the present invention can be, but not particularly limited to, for example, from 0.40 to 0.70 w/w %, preferably from 0.45 to 0.60 w/w %, and even more preferably 0.49 to 0.55 w/w %. The carbon dioxide concentration can be measured by a standard method well known to one of ordinary skill in the art. In the measurements, automated measurement devices of the conventional techniques may be employed. For example, a gas volume measurement device GVA-500A (KYOTO ELECTRONICS MANUFACTURING CO., LTD.) can be used. The gas content of the nonalcoholic beer-taste beverage is usually expressed by % by weight (w/w % or g/kg), or can be expressed by a gas pressure at 20° C. (kgf/cm² or MPa). The concentration of the carbon dioxide gas and the gas pressure can be properly converted. In the present specification, the carbon dioxide gas content is expressed by a concentration (w/w %) unless specified otherwise.

The method for producing a nonalcoholic beer-taste beverage of the present invention is not particularly limited, and the method for production is exemplified by a method for producing a nonalcoholic beer-taste beverage including adding succinic acid and/or a salt thereof. In the present production embodiment, the nonalcoholic beer-taste beverage can be produced in the same manner as any one of general nonalcoholic beer-taste beverages except that succinic acid and/or a salt thereof is added. The salts of succinic acid include well-known salts that are acceptable in foods, and, for example, alkali metal salts such as sodium salts and potassium salts and alkaline earth metal salts such as calcium salts and magnesium salts can be used. Although the commercially available preparation containing succinic acid and/or a salt thereof is not particularly limited, the commercially available preparation includes, for example, a mixed composition with a seasoning preparation such as sodium glutamate or nucleic acid, and the like. In addition, the commercially available preparation contains raw materials for general goods themselves and seasonings, and the like, and, for example, seasoning preparations such as protein degradation products of various animals or plants or an enzyme yeast, and the like can be used. General production steps for a nonalcoholic beer-taste beverage will be shown hereinbelow. A nonalcoholic general beer-taste beverage is one in which malts are used or not used as raw materials, which can be produced in the following manner.

As to the nonalcoholic beer-taste beverage produced by using malts as raw materials, first, to a mixture containing raw materials such as wheat such as malts, optionally other grains, starches, sugars, a bittering agent, or a colorant, and water is added an enzyme such as amylase optionally to carry out gelatinization or saccharification, and the mixture is then filtered, to provide a saccharified liquid. Hops, a bittering agent or the like is optionally added to the saccharified liquid, and a mixture is boiled, to remove solid contents such as coagulated proteins in a clearing tank. As a substitute for this saccharified liquid, hops may be added to a hot water added with a malt extract, and a mixture may be boiled. The hops may be mixed at any stage from the beginning of boiling to before the termination of boiling. As the conditions in the saccharification step, the boiling step, the solid content removal step, and the like, known conditions may be used. After boiling, the wort obtained is filtered, and a carbon dioxide gas is added to a filtrate obtained. Thereafter, a vessel is filled, and subjected to a sterilizing step, to obtain an intended nonalcoholic beer-taste beverage. In each of the above steps, succinic acid and/or a salt thereof may be added in any steps up to filling. Succinic acid and/or a salt thereof can be added before the boiling step of wort, from the viewpoint of microbial quality guarantee, and succinic acid and/or a salt thereof may be added immediately before filling the container, from the viewpoint of the component migration rate.

In the case of producing a nonalcoholic beer-taste beverage without using malts as raw materials, first, a liquid sugar containing a carbon source, a nitrogen source as an amino acid-containing material other than wheat or malts, hops, a pigment, and the like are mixed together with a hot water, to provide a liquid sugar-containing solution. The liquid sugar-containing solution is boiled. When hops are used as raw materials, the hops may be mixed with the liquid sugar-containing solution during boiling, not before the beginning of boiling. A carbon dioxide gas is added to the liquid sugar-containing solution after boiling. Thereafter, a vessel is filled, and subjected to a sterilizing step, to obtain an intended nonalcoholic beer-taste beverage. In each of the above steps, succinic acid and/or a salt thereof may be added in any steps up to filling. Succinic acid and/or a salt thereof can be added before the boiling step of wort, from the viewpoint of microbial quality guarantee, and succinic acid and/or a salt thereof may be added immediately before filling the container, from the viewpoint of the component migration rate.

The term “beer-taste beverage” as used herein refers to a carbonated beverage having a beer-like flavor. Among them, the term “nonalcoholic beer-taste beverage” refers to a beer-taste beverage having an alcoholicity of less than 1%, preferably 0.005% or less, and more preferably does not substantially contain an alcohol. Here, the beverage of the embodiment that substantially does not contain an alcohol does not intend to exclude a beverage containing a very small amount of alcohol to an extent that is undetectable. A beverage of which alcoholicity would be rounded off to 0.0%, and especially a beverage of which alcoholicity is rounded off to 0.00%, is embraced in the nonalcoholic beer-taste beverage. The kinds of the nonalcoholic beer-taste beverage of the present invention include, for example, nonalcoholic beer-taste beverages, beer-taste refreshing beverages, and the like. Here, the term “alcoholicity (alcohol content)” as used herein means the content of ethanol, but an aliphatic alcohol is not included therein.

The alcoholicity of the nonalcoholic beer-taste beverage according to the present invention means a content (v/v %) of an alcoholic content of the beverage, and the alcoholicity can be measured by any of known methods. For example, the alcoholicity can be measured with an oscillating densitometer. Specifically, a sample in which a carbon dioxide gas is degassed from a beverage by filtration or ultrasonication is prepared, and the sample is distilled with direct flame, and a density of the distillated solution obtained is measured at 15° C., and the alcoholicity can be converted and obtained from “Table 2 Alcoholic Content and Density (15° C.) and Specific Gravity (15/15° C.) Conversion Table” which is an annex to Internal Revenue Bureau, Specified Analysis Method (2007 Internal Revenue Bureau Order No. 6, revised Jun. 22, 2007). In a case of a low concentration with an alcoholicity of less than 1.0%, a commercially available alcohol measurement instrument or gas chromatography may be used.

In the method for production of the present invention, an aliphatic alcohol may be added to the nonalcoholic beer-taste beverage according to the present invention, from the viewpoint of giving a liquor-taste. The aliphatic alcohol is not particularly limited so long as it is a known one, and an aliphatic alcohol having 4 to 5 carbon atoms is preferred. In the present invention, preferred aliphatic alcohols include aliphatic alcohols having 4 carbon atoms such as 2-methyl-1-propanol and 1-butanol; and aliphatic alcohols having 5 carbon atoms such as 3-methyl-1-butanol, I-pentanol, and 2-pentanol. These aliphatic alcohols can be used alone or in a combination of two or more kinds. The content of the aliphatic alcohol having 4 to 5 carbon atoms is preferably from 0.0002 to 0.0007% by mass, and more preferably from 0.0003 to 0.0006% by mass. In the present specification, the content of the aliphatic alcohol can be measured by using a headspace gas chromatography.

(Calories)

Among the nonalcoholic beer-taste beverages according to the present invention, it is desired that the nonalcoholic beer-taste beverage is low in calories, matching in the favor of low-calorie diets in the recent years. Therefore, the nonalcoholic beer-taste beverage according to the present invention has the number of calories of preferably less than 5 kcal/100 mL, more preferably less than 4 kcal/100 mL, and even more preferably less than 3 kcal/100 mL.

The number of calories included in the nonalcoholic beer-taste beverage according to the present invention is basically calculated in accordance with “Method and the like for Analyzing Nutrient Ingredients etc. in Nutritional Labelling Standards” published in association with the Health Promotion Act. In other words, in principle, the number of calories can be calculated as a total sum of the amount of the various nutrient ingredients quantified multiplied by an energy conversion coefficient of each ingredient (protein: 4 kcal/g, fat: 9 kcal/g, saccharide: 4 kcal/g, dietary fibers: 2 kcal/g, alcohol: 7 kcal/g, or organic acid: 3 kcal/g). For details, see “Method and the like for Analyzing Nutrient Ingredients etc. in Nutritional Labelling Standards.”

Specific measurement methods for the amounts of each of nutrient ingredients contained in the nonalcoholic beer-taste beverage according to the present invention may be carried out in accordance with various methods of analyses described in the Health Promotion Act “Method and the like for Analyzing Nutrient Ingredients etc. in Nutritional Labelling Standards.” Alternatively, if requested to Incorporated Foundation, Japan Food Research Laboratories, one can know the calories and/or each of amounts of nutrient ingredients.

(Saccharides)

The saccharides contained in the nonalcoholic beer-taste beverage according to the present invention refer to saccharides based on the Nutritional Labelling Standards for Foods (2003 Ministry of Health. Labour, and Welfare, Announcement No. 176). Specifically, the saccharides refer to a group of foods from which proteins, fats, dietary fibers, ashes, alcohols, and water are excluded. In addition, the amount of saccharides in the foods is calculated by deduction of the amounts of proteins, fats, dietary fibers, ashes, and water from the weight of the above foods. In this case, the amounts of proteins, fats, dietary fibers, ashes, and water are measured by a method set out in the Nutritional Labelling Standards. Specifically, the amount of proteins is measured by nitrogen quantification conversion method; the amount of fats is measured by an ether extraction method, a chloroform-methanol liquid mixture extraction method, a Gerber method, an acid decomposition method or a Roese-Gottlieb method; the amount of dietary fibers is measured by high-performance liquid chromatography or Prosky method; the amount of ashes is measured by a method of ashing with magnesium acetate, a direct ashing method, or a method of ashing with sulfuric acid; and the amount of water is measured by Karl-Fischer method, a method using a drying aid, a vacuum thermal drying method, an atmospheric thermal drying method, or a plastic film method.

It is desired that the nonalcoholic beer-taste beverage according to the present invention is low in saccharides, matching in the favor of the low carbohydrate diet in the recent year. Therefore, the content of the saccharide of the nonalcoholic beer-taste beverage according to the present invention is preferably less than 0.5 g/100 mL, more preferably 0.4 g/100 mL or less, and even more preferably 0.3 g/100 mL or less. In addition, the lower limit of the content is, but not particularly set, usually 0.1 g/100 mL or so, which may be, for example, 0.15 g/100 mL or more, and 0.2 g/100 mL or more.

(Acidulant)

As the acidulant used in the method for production according to the present invention, it is preferable to use one or more acids selected from the group consisting of citric acid, lactic acid, phosphoric acid, and malic acid. In addition, in the method for production of the present invention, as an acid other than the above acids, tartaric acid, fumaric acid, glacial acetic acid or the like can be used. These acidulants can be used without limitations so long as the acidulants are accepted to be added to foods. In the method for production of the present invention, it is preferable to use a combination of lactic acid from the viewpoint of appropriately giving a moderate sour taste, and phosphoric acid from the viewpoint of appropriately giving an sour taste with a slightly stimulating taste.

The content of the acidulant in the nonalcoholic beer-taste beverage according to the present invention, calculated in terms of citric acid, is preferably 200 ppm or more, more preferably 550 ppm or more, and even more preferably 700 ppm or more, from the viewpoint of providing a beer-like taste, and the content is preferably 15000 ppm or less, more preferably 5500 ppm or less, and even more preferably 2000 ppm or less, from the viewpoint of acidity. Therefore, in the present invention, the content of the acidulant, calculated in terms of citric acid, includes preferred ranges such as from 200 ppm to 15000 ppm, preferably from 550 ppm to 5500 ppm, and more preferably from 700 ppm to 1500 ppm. Here, the amount calculated in terms of citric acid as used herein refers to an amount converted from an acidity of each of the acidulants on the basis of the acidity of citric acid. For example, the amount which is equivalent to 100 ppm of lactic acid, calculated in terms of citric acid, is 120 ppm, the amount which is equivalent to 100 ppm of phosphoric acid, calculated in terms of citric acid, is 200 ppm, and the amount which is equivalent to 100 ppm of malic acid, calculated in terms of citric acid, is 125 ppm.

The content of the acidulant in the nonalcoholic beer-taste beverage refers to those calculated by analyzing with high-performance liquid chromatography (HPLC) or the like.

(Hops)

In the method for production of the present invention, hops can be used as a part of the raw materials. Since the flavor tends to resemble beer, it is desired that hops are used in a part of the raw materials. When hops are used, usual pellet hops, powder hops or a hop extract used in the production of beer and the like can be appropriately selected and used in accordance with a desired flavor. In addition, hop working products such as isomerized hops and reduced hops may be used. The hops used in the nonalcoholic beer-taste beverage according to the present invention embrace those products. Also, the amount of the hops is, but not particularly limited to, typically from 0.0001 to 1% by weight or so, based on the entire amount of the beverage.

(Other Raw Materials)

In the method for production according to present invention, other raw materials may be optionally used within the range that would not inhibit the effects of the present invention. For example, a sweetener (including a high-intensity sweetener), a bittering agent, a flavor (aromatic), an yeast extract, a colorant such as a caramel pigment, vegetable extracted saponin-based material such as soybean saponin or quillai saponin, a vegetable protein- and peptide-containing product such as maize or soybeans, an animal protein such as whey, dietary fibers, a seasoning such as amino acids, or an antioxidant such as ascorbic acid can optionally be used within the range that would not inhibit the effects of the present invention.

Thus, a nonalcoholic beer-taste beverage according to the present invention is obtained. The pH of the nonalcoholic beer-taste beverage according to the present invention is from 3.0 to 5.0, preferably from 3.5 to 4.5, and more preferably 3.5 to 4.0, from the viewpoint of making the flavor of the beverage favorable.

(Container-Packed Beverage)

The nonalcoholic beer-taste beverage according to the present invention can be packed into a container. The shapes of the containers are not limited in any manners, and the nonalcoholic beer-taste beverage can be packed into a tightly sealed container such as a glass bottle, a can, a barrel, or a plastic bottle, whereby a beverage contained in a container can be provided.

The present invention also provides a method of giving a stimulating taste to a nonalcoholic beer-taste beverage including adding succinic acid and/or a salt thereof. According to the method of giving a stimulating taste of the present invention, the stimulating taste of the nonalcoholic beer-taste beverage can be improved without increasing a carbon dioxide gas pressure. In addition to the method for giving a stimulating taste of the present invention, the carbon dioxide gas pressure can be increased or decreased. The details of each component and the like in the method for giving a stimulating taste of the present invention are as explained above.

### EXAMPLES

The present invention will be specifically described hereinbelow by the Examples, without intending to limit the scope of the present invention to the following Examples.

<Preparation of Nonalcoholic Beer-Taste Beverages>

### Examples 1 to 5 and Comparative Examples 1 and 2

To a commercially available nonalcoholic beer-taste beverage (Reference Example 1, manufactured by Suntory Holdings Limited under the trade name of ALL-FREE) was added disodium succinate hexahydrate (manufactured by marugo corporation) so as to have a concentration as listed in Table 1, to give a nonalcoholic beer-taste beverage. Here, although disodium succinate hexahydrate is used, the concentrations as listed in Table 1 are concentrations in terms of succinic acid.

With respect to the beer-taste beverages obtained, the relative scoring was carried out by six specialized panelists on the bases of the following evaluation criteria by defining the score of Reference Example 1 as “0.5,” the scoring being made in an increment of 0.25, and a mean score of the scores of the six specialized panelists was calculated. On the basis of this mean score, the extent of the enhanced effects of the stimulating taste was indicated by symbols x to ⊚, in accordance with the following criteria. When the judgments were Δ or higher, it is found that the stimulating taste is enhanced. The results are shown in Table 1.

### (Scores for Stimulating Taste)

0: Not tasted at all;
1: Faintly tasted;
2: Distinctively tasted; and
3: Highly Strongly tasted.

### (Evaluation Criteria for Stimulating Taste)

x: Score for stimulating taste is less than 1.0;
Δ: Score for stimulating taste is 1.0 or more and less than 1.5;
∘: Score for stimulating taste is 1.5 or more and less than 2.0; and
⊚: Score for stimulating taste is 2.0 or more.

TABLE 1

| | Ref. | Comp. | | Ex. | | Ex. | | Comp. |
|---|---|---|---|---|---|---|---|---|
| | Ex. 1 | Ex. 1 | Ex. 1 | 2 | Ex. 3 | 4 | Ex. 5 | Ex. 2 |
| Content of | 1.5 | 3.7 | 5.9 | 8.1 | 10.0 | 12.0 | 23.0 | 45.0 |
| Succinic Acid, | | | | | | | | |
| ppm | | | | | | | | |
| Evaluation of | — | X | Δ | ◯ | ◯ | ⊚ | ◯ | X |
| Stimulating | | | | | | | | |
| Taste | | | | | | | | |

It could be seen from the results of Table 1 that the nonalcoholic beer-taste beverages of each of Examples where the content of succinic acid is from 5 to 24 ppm all have excellent stimulating tastes.

### INDUSTRIAL APPLICABILITY

According to the present invention, a beer-taste beverage with a new taste having an excellent stimulating taste can be provided.

1. A nonalcoholic beer-taste beverage wherein the content of succinic acid is from 5 to 24 ppm.

2. A method for producing a nonalcoholic beer-taste beverage as defined in claim 1, comprising adding succinic acid and/or a salt thereof.

3. A method of giving a stimulating taste to a nonalcoholic beer-taste beverage comprising adding succinic acid and/or a salt thereof.
